(19) United States
(12) Patent Application Publication
(10) Pub. No.: US 2017/0185454 A1
(43) Pub. Date: Jun. 29, 2017

(54) Method and Electronic Device for Determining Resource Consumption of Task

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Luqing XU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,389

(22) Filed: Aug. 19, 2016

Related U.S. Application Data
(63) Continuation of application No. PCT/CN2016/089272, filed on Jul. 7, 2016.

(30) Foreign Application Priority Data
Dec. 25, 2015 (CN) 201510997430.X

(51) Int. Cl. G06F 9/50

(52) U.S. Cl. CPC G06F 9/5038; G06F 9/505; H04L 67/1097

(57) ABSTRACT

A method and an electronic device for determining resource consumption of task is provided in the present disclosure. The method includes: obtaining task records of a cluster task, the task records including task processes started in executing the cluster task; calculating resource occupying time of a preset unit resource occupied by each of the task processes; counting a total resource occupying time of the preset unit resource occupied by a plurality of task processes started by the cluster task; and determining the cluster resources consumed in executing the cluster task, according to the total resource occupying time and the preset unit resource. The present disclosure is capable of determining cluster resources consumed when each cluster task is executed, so as to track resources consumed by a cluster task calculated in a cluster, per day.

### CROSS REFERENCE TO RELATED APPLICATION

The present application is a continuation of international application No. PCT/CN2016/089272 filed on Jul. 7, 2016, and claims the priority of a Chinese patent application No. 201510997430.X, entitled “Method and device for determining resource consumption of task” filed with the State Intellectual Property Office of China on Dec. 25, 2015, both of which are incorporated herein by reference in their entireties.

### TECHNICAL FIELD

The present disclosure relates to a computer technology, and specifically, to a method and an electronic device for determining resource consumption of task.

### BACKGROUND

Hadoop brings about a distributed file system (Hadoop Distributed File System), which is referred to as HDFS for short. Users can develop distributed programs to achieve high-speed operation and storage by use of clusters, without knowing low-level details of the distributed file system. A plurality of nodes are generally included in a cluster, and CPU resources and storage resources are included in each node.

In a practical application, a Hadoop cluster of a firm may be shared by a number of developers in the firm. As each task submitted to the cluster will consume a certain amount of resources, such as CPU resources and storage resources, when being executed, a resource competition may occur for programs submitted by the developers that consume a lot of cluster resources, which may affect other tasks in the cluster.

### SUMMARY

In order to overcome the problems in the related art, a method and an electronic device for determining resource consumption of task is provided, according to embodiments of the present disclosure.

According to a first aspect of embodiments of the present disclosure, a method for determining resource consumption of task is provided, including:

obtaining task records of a cluster task, the task records including task processes started in executing the cluster task;

calculating resource occupying time of a preset unit resource occupied by each of the task process;

counting a total resource occupying time of the preset unit resource occupied by a plurality of task processes started by the cluster task; and

determining the cluster resources consumed in executing the cluster task, according to the total resource occupying time and the preset unit resource.

According to a second aspect of embodiments of the present disclosure, there provides a non-volatile computer-readable storage medium which is stored with computer executable instructions, the computer executable instructions being set to execute any one of the above methods for determining resource consumption of task of the present disclosure.

According to a third aspect of embodiments of the present disclosure, there provides an electronic device including at least one processor and a memory communicably connected with the at least one processor and storing instructions executable by the at least one processor, wherein execution of the instructions by the at least one processor causes the at least one processor to execute any one of the above methods for determining resource consumption of task of the present disclosure.

The technical scheme provided in embodiments of the present disclosure may include the advantages as follows.

The present disclosure discloses: obtaining task records of a cluster task, the task records including task processes started in executing the cluster task; calculating resource occupying time of a preset unit resource occupied by each of the task processes; counting a total resource occupying time of the preset unit resource occupied by a plurality of task processes started by the cluster task; and determining the cluster resources consumed in executing the cluster task, according to the total resource occupying time and the preset unit resource.

According to the method provided in embodiments of the present disclosure, cluster resources that are occupied when each cluster task is being executed, can be determined, so as to track resources consumed by a cluster task executed in a cluster per day, make analysis based on departments, users or professions to find out the cluster task that occupies the least resources, and count resource consumption of each department or service line. Therefore, calculating task of each department is optimized, and cost of cluster construction is controlled.

It should be understood that the above general description and the following detailed explanations are exemplary and illustrative, and the present disclosure is not limited thereto.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

To illustrate embodiments of the present invention or technical schemes in the prior art more clearly, figures used in the description of embodiments or the prior art are described briefly as follows. It is obvious that one of ordinary skilled in the art can obtain other figures according to those following figures without any creative work.

FIG. 1 is a flowchart illustrating a method for determining resource consumption of task, according to an embodiment;

FIG. 2 is another flowchart illustrating a method for determining resource consumption of task, according to an embodiment;

FIG. 3 is another flowchart illustrating a method for determining resource consumption of task, according to an embodiment;

FIG. 4 is a structure diagram illustrating a device for determining resource consumption of task, according to an embodiment; and

FIG. 5 is a schematic structure diagram of an electronic device for determining resource consumption of task, according to an embodiment.

### DETAILED DESCRIPTION

Embodiments are described in detail herein, examples of which are illustrated in figures. In the following descriptions, unless indicated otherwise, same reference numerals in different figures indicate same or similar elements. The implementations described in the following embodiments do not represent all implementations according to the present invention. On the contrary, they are merely examples of electronic devices and methods according to some aspects of the present invention, as defined in the attached claims.

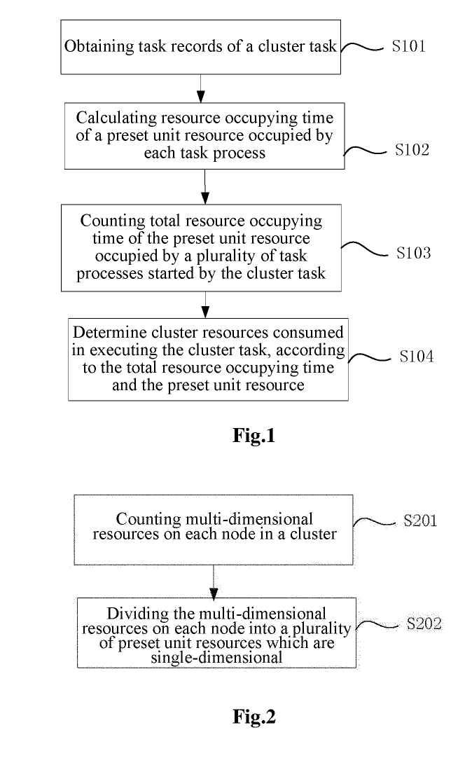

As illustrated in FIG. 1, a method for determining resource consumption of task according to another embodiment of the disclosure is provided, which is applicable in a server, including the following steps.

In step S101, task records of a cluster task are obtained.

In the present embodiment of the present disclosure, the task records may include task processes which are started in executing the cluster task, and the server may obtain task records of the cluster task through a preset interface, in a load-balancing manner.

In this step, the cluster task is a task delivered to a Hadoop cluster. For each of the MapReduce tasks execution of which is completed, JobTracker may record detailed information of the task, and the information may include basic configuration information and specific execution information of the MapReduce task. Such information is obtained from the website and respective sub-pages of the JobTracker; and data collecting program thereof is a Newlisp script requesting access to contents on a specific page of JobTracker site through Http Get, analyzing the contents and obtaining detailed information of the specific MapReduce task. Generally, the information collected is classified into 3 categories:

1) basic information of a task

including: task Id, user name, task name, Hive execution statements, task delivery machine, task delivery machine ip, task delivery time, task launch time, task launch time consumption, task ending time, total task time consumption, task execution result and failure information;

2) statistical information of task execution

including: the number of various tasks, the number of tasks that are successfully executed, the number of failed tasks, the number of tasks that are killed, starting time, ending time and total time consumption of each of stages (Setup, Map, Reduce, Cleanup), and statistical value of each Counter; and

3) detailed information of execution of each Attempt of each Task

including: id of Attempt, corresponding task id, starting time of Attempt, ending time of Shuffle stage, time consumption of Shuttle stage, ending time of Sort stage, time consumption of Sort stage, ending time of Attempt, total time consumption, execution machine, executing results, error information and the number of Counters.

As for each MapReduce task, the programs may collect the above 3 types of information into one task record, and transmit it to the server by way of Http. The server may receive the data transmitted by the programs by way of REST API. A scheme of LVS+Nginx+dual-machine load-balancing is employed to avoid single-point, and a MongoDB tri-machine cluster is used by database, to ensure high performance of data storage and absence of single-point.

In step S102, resource occupying time of a preset unit resource occupied by each task process is calculated.

In an embodiment of the disclosure, a preset unit resource may refer to a Slot. Attempting processes started by each task process are obtained, for each task process. Resource occupying time of the preset unit resource occupied by attempting processes that are successfully executed, is counted, when the attempting processes that are successfully executed exist.

In this step, when a cluster task (e.g. MapReduce task) is running, it always needs to run a certain number of Map Tasks and Reduce Tasks. However, a Slot is to be occupied for a period of time, that is, certain resources on a machine are to be occupied for a period of time, for the running of each task process (i.e. Task).

Each cluster task (e.g. MapReduce task) includes a number of task processes (i.e. Task), and each task process may include a plurality of attempting processes (i.e. Attempt), each of which is an attempt for the task process. An attempting process may come to a failure or be executed at an exceptionally low speed due to an abnormal execution at a node, when the attempting process is being executed, and thus another attempting process will be started by calculating framework for execution of a same task process. This mechanism is employed in Hadoop clusters to ensure that each task process can be successfully executed and an execution of a task will not be executed for too long time due to slowness of a task process.

As a plurality of attempting processes of each task process are mostly due to abnormity in a calculating node of cluster, time cost of running the plurality of attempting processes should not be repeatedly calculated for each task, that is, a sum of execution time of all attempting processes that are successfully executed in a task is calculated as the total execution time of the task processes of the task.

In step S103, a total resource occupying time of a preset unit resource occupied by a plurality of task processes started by the cluster task, is counted.

In the step, the resource occupying time of the preset unit resource occupied by each task process is summed up to obtain the total resource occupying time.

In step S104, the cluster resource consumed in executing the cluster task, is determined according to the total resource occupying time and the preset unit resource.

As the number of machines in a Hadoop cluster is limited, and thus the number of slots provided in each machine is definite, execution time for Map Task and Reduce Task that the cluster can provide per day, is also definite. Consequently, according to the method provided in the disclosure, the cluster resources that are occupied when each cluster task is being executed, can be determined, so as to track the resources consumed by the cluster task executed in the cluster every day, make analysis based on departments, users or professions to find out the cluster task that occupies the least resources, and count the resource consumption of each department or service line. Therefore, calculating task of each department is optimized, and cost of cluster construction is controlled.

As illustrated in FIG. 2, according to another embodiment of the disclosure, the method may further include the following steps.

In step S201, multi-dimensional resources on each node of a cluster are counted.

In step S202, the multi-dimensional resources on each node are divided into a plurality of preset unit resources that are single-dimensional.

In this step, the multi-dimensional resources (CPU, memory, network I/O, disk I/O or the like) on each node are divided into a plurality of single-dimensional Slot. In view of the difference in resource consumption between Map Task and Reduce Task, a Slot is further divided into Map Slot and Reduce Slot, and Map Task may only use Map Slot while Reduce Task may only use Reduce Slot.

According to the embodiment of the disclosure, resources on each node can be divided to obtain a plurality of preset unit resources that are single-dimensional, such that a total resource occupying time of a cluster task is determined according to a period of time of a preset unit resource occupied by each task process.

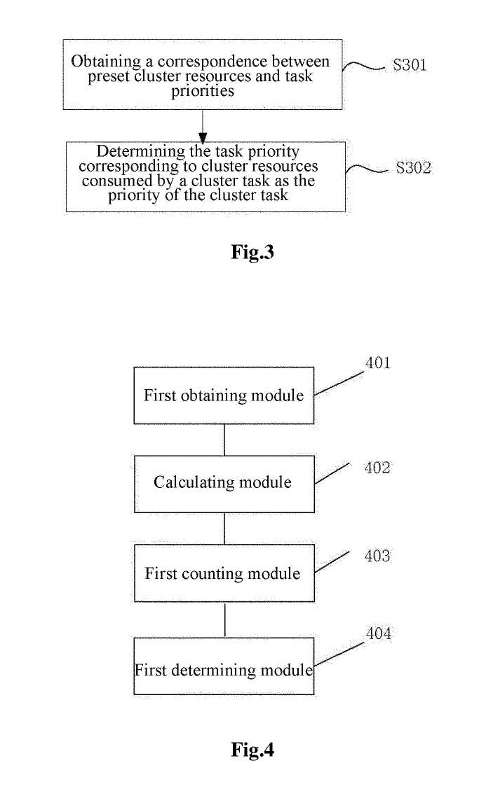

As illustrated in FIG. 3, according to yet another embodiment of the disclosure, the method may further include the following steps.

In step S301, correspondence between preset cluster resources and task priorities is obtained.

In this step, it is assumed that the correspondence between the preset cluster resources and the task priorities is correspondence between a threshold range of the cluster resources and the task priorities, for example, when the threshold range of the cluster resources is 100 to 200, its corresponding priority is 2.

In step S302, the task priority corresponding to the cluster resources consumed by the cluster task, is determined as the priority of the cluster task.

According to the method provided in the embodiment of the disclosure, the priority of the cluster task is determined according to the resource consumption of the cluster task, such that the cluster task is scheduled based on the priority of the task.

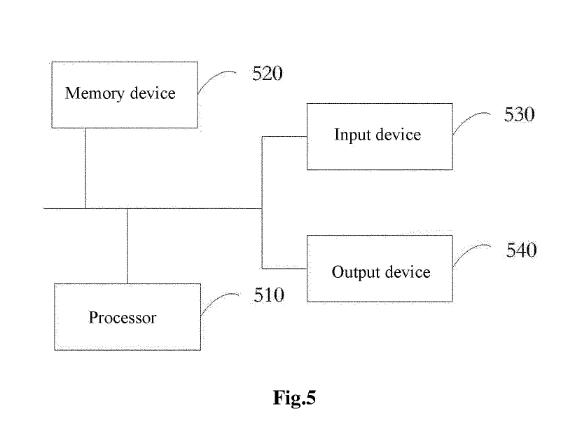

As illustrated in FIG. 4, according to still another embodiment of the disclosure, a device for determining task resource consumption is provided, including a first obtaining module 401, a calculating module 402, a first counting module 403 and a first determining module 404.

The first obtaining module 401 obtains task records of a cluster task, the task records including task processes started in executing the task.

According to an embodiment of the disclosure, a second obtaining sub-module obtains the task records of the cluster task through a preset interface, in a load-balancing manner.

The calculating module 402 calculates resource occupying time of a preset unit resource occupied by each task process.

In an embodiment of the disclosure, the calculating module may include:

a first obtaining sub-module configured to, for each of the task processes, obtain attempting processes started by the task process; and

a counting sub-module configured to count resource occupying time of a preset unit resource occupied by attempting processes that are successfully executed, when the attempting processes that are successfully executed exist.

The first counting module 403 counts a total resource occupying time of the preset unit resource occupied by a plurality of task processes started by the cluster task.

The first determining module 404 determines cluster resources consumed in executing the cluster task, according to the total resource occupying time and the preset unit resource.

According to a further embodiment of the disclosure, the device may further include a second counting module and a dividing module.

The second counting module counts multi-dimensional resources on each node of a cluster.

The dividing module divides the multi-dimensional resources on each node into a plurality of preset unit resources which are single-dimensional.

According to another further embodiment of the disclosure, the device may further include a second obtaining module and a second determining module.

The second obtaining module obtains a correspondence between preset cluster resources and task priorities.

The second determining module determines the task priority corresponding to the cluster resources consumed by the cluster task, as the priority of the cluster task.

The embodiments of the present disclosure further provide a non-volatile computer storage medium, and the non-volatile computer storage medium is stored with computer executable instructions which are used to perform any of the methods for determining resource consumption of task in the above embodiments.

FIG. 5 is a schematic structure diagram of an electronic device for determining resource consumption of task according to an embodiment. The device includes one or more processors 510 and a memory device 520, and FIG. 5 illustrates one processor 510 as an example.

The device for determining resource consumption of task may further include an input device 530 and an output device 540.

The processor 510, memory device 520, input device 530 and output device 540 is connected with each other through a bus or other forms of connections. FIG. 5 illustrates a bus connection as an example.

As a non-volatile computer readable storage medium, the memory device 520 is configured to store non-volatile software program, non-volatile computer executable program and modules, such as program instructions/modules corresponding to the method for determining resource consumption of task according to the embodiments of the disclosure (for example, the first obtaining module 401, calculating module 402, first counting module 403 and first determining module 404, as illustrated in FIG. 4). By executing the non-volatile software program, instructions and modules stored in the memory device 520, the processor 510 may perform various functional applications of the server and data processing, that is, the method for determining resource consumption of task according to the above mentioned embodiments.

The memory device 520 may include a program storage area and a data storage area, the program storage area is stored with the operating system and applications which are needed by at least one functions, and the data storage area is stored with data which is created according to use of the device for determining resource consumption of task. Further, the memory device 520 may include a high-speed random access memory, and may further include non-volatile memory, such as at least one of disk memory device, flash memory device or other types of non-volatile solid state memory device. In some embodiments, optionally, the memory device 520 may include memory device provided remotely from the processor 510, and such memory device is connected with the device for determining resource consumption of task through network connections. The examples of the network connections may include but not limited to internet, intranet, LAN (Local Area Network), mobile communication network or combinations thereof.

The input device 530 may receive inputted digital or character information, and generate key signal input related to the user settings and functional control of the device for determining resource consumption of task. The output device 540 may include a display device such as a display screen.

The above one or more modules is stored in the memory device 520, when these modules are executed by the one or more processor 510, the method for determining resource consumption of task according to any one of the above mentioned embodiments is performed.

The above product may perform the methods provided in the embodiments of the disclosure, include functional modules corresponding to these methods and advantageous effects. Further technical details which are not described in detail in the present embodiment may refer to the methods provided according to embodiments of the disclosure.

The electronic device in the embodiment of the present disclosure is embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component is or may not be physically separated, the component illustrated as a unit is or may not be a physical unit, in other words, is either disposed in a same place or distributed to a plurality of network units. All or part of modules is selected as actually required to realize the objects of the present disclosure. Such selection is understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art is embodied in a form of a software product which can be stored in a computer-readable storage medium, such as ROM/RAM, magnetic disk and compact disc, and includes several instructions for allowing a computer device (which is a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for determining resource consumption of a task, comprising at an electronic device:
obtaining task records of a cluster task, the task records comprising task processes started in executing the cluster task;
calculating a resource occupying time of a preset unit resource occupied by each of the task processes;
counting a total resource occupying time of the preset unit resource occupied by a plurality of task processes started by the cluster task; and
determining cluster resources consumed in executing the cluster task, according to the total resource occupying time and the preset unit resource.

2. The method for determining resource consumption of task according to claim 1, further comprising:
counting multi-dimensional resources on each of nodes in a cluster; and
dividing the multi-dimensional resources on each of nodes into a plurality of preset unit resources which are single-dimensional.

3. The method for determining resource consumption of task according to claim 1, further comprising:
obtaining a correspondence between preset cluster resources and task priorities; and
determining the task priorities corresponding to the cluster resources consumed by the cluster task, as the priority of the cluster task.

4. The method for determining resource consumption of task according to claim 1, wherein, the task records comprise attempting processes, and
the calculating the resource occupying time of the preset unit resource occupied by each of the task processes during its corresponding process time comprises:
obtaining for each of the task processes, attempting processes started by the task process; and
counting resource occupying time of the preset unit resource occupied by attempting processes that are successfully executed, when the attempting processes that are successfully executed exist.

5. The method for determining resource consumption of task according to claim 4, wherein, the obtaining the task records of the cluster task comprises:
obtaining the task records of the cluster task through a preset interface in a load-balancing manner.

6. A non-volatile computer-readable storage medium, which is stored with computer executable instructions that, when executed by an electronic device, cause the electronic device to:
obtain task records of a cluster task, the task records comprising task processes started in executing the cluster task;
calculate a resource occupying time of a preset unit resource occupied by each of the task processes;
count a total resource occupying time of the preset unit resource occupied by a plurality of task processes started by the cluster task; and
determine cluster resources consumed in executing the cluster task, according to the total resource occupying time and the preset unit resource.

7. The non-volatile computer storage medium according to claim 6, wherein, the electronic device is further caused to:
count multi-dimensional resources on each of nodes in a cluster; and
divide the multi-dimensional resources on each of nodes into a plurality of preset unit resources which are single-dimensional.

8. The non-volatile computer storage medium according to claim 6, wherein, the electronic device is further caused to:
obtain a correspondence between preset cluster resources and task priorities; and
determine the task priorities corresponding to the cluster resources consumed by the cluster task, as the priority of the cluster task.

9. The non-volatile computer storage medium according to claim 6, wherein, the task records comprises attempting processes, and
the calculating the resource occupying time of the preset unit resource occupied by each of the task processes during its corresponding process time comprises:
obtaining, for each of the task processes, attempting processes started by the task process; and
counting resource occupying time of the preset unit resource occupied by attempting processes that are successfully executed, when the attempting processes that are successfully executed exist.

10. The non-volatile computer storage medium according to claim 9, wherein, the obtaining the task records of the cluster task comprises:
obtaining the task records of the cluster task through a preset interface in a load-balancing manner.

11. An electronic device, comprising:
at least one processor; and
a memory, communicably connected with the at least one processor and storing instructions executable by the at least one processor,
wherein execution of the instructions by the at least one processor causes the at least one processor to:
obtain task records of a cluster task, the task records comprising task processes started in executing the cluster task;
calculate a resource occupying time of a preset unit resource occupied by each of the task processes;
count a total resource occupying time of the preset unit resource occupied by a plurality of task processes started by the cluster task; and
determine cluster resources consumed in executing the cluster task, according to the total resource occupying time and the preset unit resource.

12. The electronic device according to claim 11, wherein, the at least one processor is further caused to:
count multi-dimensional resources on each of nodes in a cluster; and
divide the multi-dimensional resources on each of nodes into a plurality of preset unit resources which are single-dimensional.

13. The electronic device according to claim 11, wherein, the at least one processor is further caused to:
obtain a correspondence between preset cluster resources and task priorities; and
determine the task priorities corresponding to the cluster resources consumed by the cluster task, as the priority of the cluster task.

14. The electronic device according to claim 11, wherein, the task records comprises attempting processes, and
the calculating the resource occupying time of the preset unit resource occupied by each of the task processes during its corresponding process time comprises:
obtaining, for each of the task processes, attempting processes started by the task process; and
counting resource occupying time of the preset unit resource occupied by attempting processes that are successfully executed, when the attempting processes that are successfully executed exist.

15. The electronic device according to claim 14, wherein, the obtaining the task records of the cluster task comprises:
obtaining the task records of the cluster task through a preset interface in a load-balancing manner.
